(19) United States
(12) Patent Application Publication
(10) Pub. No.: US 2011/0018169 A1
(43) Pub. Date: Jan. 27, 2011

(54) METHOD OF MANUFACTURING PLASMA DISPLAY PANEL AND METHOD OF PRODUCING MAGNESIUM OXIDE CRYSTAL POWDER

(76) Inventors: Tomonari Misawa, Yokohama (JP); Tadayoshi Kosaka, Yokohama (JP); Yoshiho Seo, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/863,613

(22) PCT Filed: Mar. 5, 2008
(86) PCT No.: PCT/JP2008/053975

§ 371 Date: Oct. 12, 2010

(51) Int. Cl. B29C 39/38; B28B 11/06

(52) U.S. Cl. 264/319

(57) ABSTRACT

A method of manufacturing a plasma display panel (PDP) in which a priming particle emitting layer containing magnesium oxide crystal powder is arranged, the plasma display panel both achieving improvement effects of generation of clusters of magnesium oxide crystal and discharge delay. A typical embodiment of the present invention is a method of manufacturing a PDP in which a priming particle emitting layer which contains magnesium oxide crystal powder subjected to a high-temperature heating treatment is arranged to be exposed to a discharge space, wherein, in a thermal treatment process of raw material magnesium oxide crystal powder, the high-temperature heating treatment is performed after shapes and sizes of the magnesium oxide crystal powder are uniformed.

### TECHNICAL FIELD

The present invention relates to a plasma display panel (PDP) and a method of manufacturing the same, and more particularly, it relates to a technique effectively applied to magnesium oxide crystal powder to be contained in a priming particle emitting layer (electron emission layer) and a method of producing the same.

### BACKGROUND ART

Achievement of higher definition in PDPs has been advanced and time for address operations for selecting and determining turning on/off of display cells is thus increased as the number of pixels is increased. To suppress the increase, it is effective to reduce a pulse width of a voltage (address voltage) for an address discharge. However, time (discharge delay) from voltage application to discharge generation varies. Therefore, when the pulse width of address voltage is too small, discharge may not be generated even when a pulse is applied. This case causes an image quality degradation as display cells are not turned on in a sustain period.

As means for improving the discharge delay in PDPs, as described in Japanese Patent Application Laid-Open Publication No. 2006-59786 (Patent Document 1), there is a technique of providing a magnesium oxide crystal layer as a priming particle emitting layer (electron emitting layer) being exposed to a discharge space between two plate structures arranged to face each other.

### Patent Document 1: Japanese Patent Application Laid-Open Publication No. 2006-59786

### DISCLOSURE OF THE INVENTION

### Problems to be Solved by the Invention

As means for obtaining a higher discharge delay improving effect in the above-mentioned magnesium oxide crystal layer, according to Japanese Patent Application Laid-Open Publication No. 2007-124718 previously filed by the inventors of the present invention, there is a technique of mixing halogen in magnesium oxide crystal powder and baking the same. In addition, according to PCT/JP2007/68348 previously filed by the inventors of the present invention, there is a technique of performing a thermal treatment in an oxidizing atmosphere on magnesium oxide crystal powder.

However, clusters (clusters of magnesium oxide crystal) may exist in the magnesium oxide crystal powder after the thermal treatments by these techniques. When large clusters exist in a priming particle emitting layer in a PDP, s display failure may occur as the clusters disturb spread of discharge, or s display unevenness may occur due to variations in characteristics among cells.

As methods for eliminating the clusters, there are a method of performing a grinding (crushing) treatment by a mortar and a pestle on magnesium oxide crystal powder after a thermal treatment, and a method of performing a dispersion treatment by such as ultrasonic wave on a slurry upon wet application to the panel. However, these methods may destroy crystals of the magnesium oxide and reduce the discharge delay improving effect.

The present invention has been made in view of the above problems, and a preferred aim of the present invention is to provide a technique achieving both a suppression of generating the clusters of magnesium oxide crystal in the magnesium oxide crystal powder after thermal treatment and a discharge delay improving effect.

### Means for Solving the Problems

The typical ones of the inventions disclosed in the present application will be briefly described as follows. That is, a method of manufacturing a PDP according to a typical embodiment of the present invention is for manufacturing a PDP in which a priming particle emitting layer containing magnesium oxide crystal powder subjected to a high-temperature heating treatment is arranged, wherein the high-temperature heating treatment is performed after a pretreatment process for uniforming shapes and sizes of particle groups of source magnesium oxide crystal particles.

### EFFECTS OF THE INVENTION

The effects obtained by typical aspects of the present invention will be briefly described below. More specifically, according to the typical embodiment of the present invention, since contacts of particle groups to each other during a high-temperature heating is reduced, and thus magnesium oxide crystal powder having suppressed generation of the clusters of magnesium oxide crystal can be obtained without losing a discharge delay improving effect. By disposing a priming particle emitting layer containing magnesium oxide crystal powder, a PDP in which both an improvement in discharge delay and a suppression of display failure and display unevenness can be achieved.

### BRIEF DESCRIPTIONS OF THE DRAWINGS

FIG. 1 is a diagram illustrating an outline of an example of a pretreatment for uniforming shapes and sizes of particle groups according to a first embodiment of the present invention;

FIG. 2 is a diagram illustrating a manufacture flow of magnesium oxide crystal powder and a priming particle emitting layer including the pretreatment according to the first embodiment of the present invention;

FIG. 3 is a diagram illustrating an outline of an example of a pretreatment for uniforming shapes and sizes of particle groups according to a second embodiment of the present invention;

FIGS. 4A and 4B are diagrams illustrating examples of fusion bonding when heating particles (particle groups) at high temperature;

FIG. 5 is a diagram illustrating an example of a basic structure of a PDP which is an embodiment of the present invention as an exploded perspective configuration with enlarging a main part; and

FIG. 6 is a diagram illustrating an example of a cross-sectional configuration of a front plate structure including a priming particle emitting layer in a PDP according to an embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

<Outline>

In a method of manufacturing a PDP which is an embodiment of the present invention, to achieve both a suppression of generating the clusters of magnesium oxide crystal in the magnesium oxide crystal powder after a thermal treatment and a discharge delay improving effect, which are the problems in a priming particle emitting layer mentioned above, in a thermal treatment process of magnesium oxide crystal powder, before performing a thermal treatment, shapes and sizes of particle groups of magnesium oxide crystal powder which is a raw material are uniformed so that contacts between particle groups during a high-temperature heating treatment is reduced.

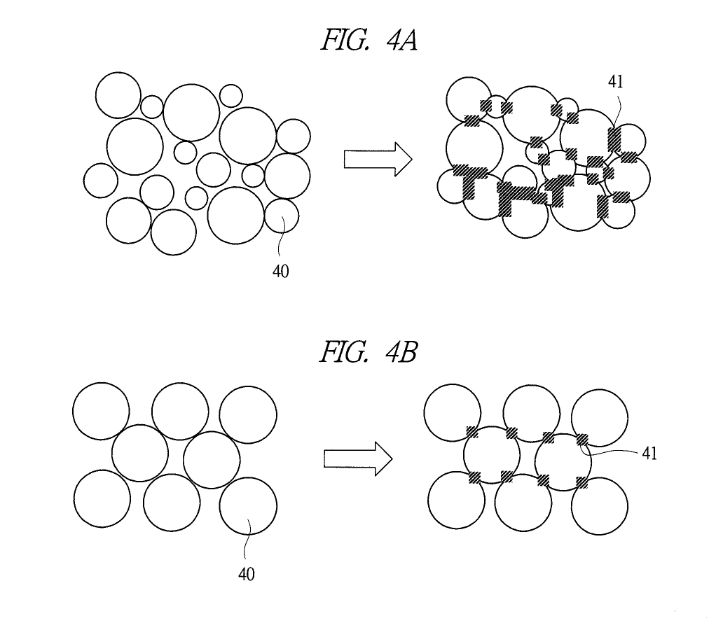

Here, generation of clusters (segregation) of particles or particle groups occurs when particles (particle groups) contacting each other come into fusion bonding. FIGS. 4A and 4B are diagrams illustrating examples of states of fusion bonding when subjecting particles (particle groups) into a high-temperature heating treatment. As illustrated in FIG. 4A, during the high-temperature heating, when shapes and sizes of particles (particle groups) 40 are not uniform, contacts between the particles (particle groups) increase and areas of fusion bondings 41 after the high-temperature heating are increased, and thus segregation is strengthened. On the contrary, as illustrated in FIG. 4B, when shapes and sizes of the particles (particle groups) are uniform, contacts between the particles (particle groups) 40 are suppressed to minimum and areas of the fusion bondings after a high-temperature heating is reduced, and thus segregation is weakened.

Therefore, before performing the high-temperature heating treatment to the magnesium oxide crystal powder, shapes and sizes of particles (particle groups) are uniformed when they are not uniform so that contacts between particles (particle groups) are reduced, thereby suppressing segregation (generation of clusters) due to fusion bonding between particles (particle groups) during a high-temperature heating treatment. By using the magnesium oxide crystal powder with suppressed generation of clusters of magnesium oxide crystal is used in a priming particle emitting layer, a PDP achieving both an improvement in discharge delay and a suppression of display failure and display unevenness can be achieved.

<PDP (Basic Structure)>

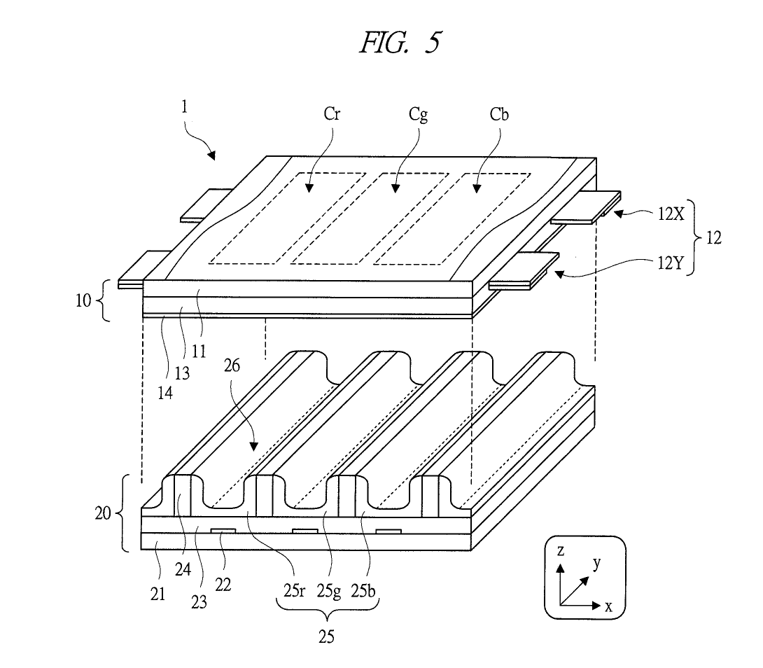

FIG. 5 is a diagram illustrating an example of a basic structure of a PDP (panel) 1 which is an embodiment of the present invention. In FIG. 5, a portion of a set of display cells (Cr, Cg, Cb) corresponding to a pixel is illustrated. Note that, for the description, an x direction (first direction, horizontal direction), a y direction (second direction, vertical direction), and a z direction (third direction, perpendicular direction to a panel surface) are illustrated.

The PDP 1 is formed by assembling a front plate structure 10 and a rear plate structure 20, and has discharge spaces 26 therebetween. In the front plate structure 10, on a front glass substrate 11, a display electrode 12 (12X, 12Y) group is arranged in the x direction. The display electrodes 12 include a sustain electrode 12X for sustain operation and a scan electrode 12Y for sustain operation and scan operation (dual use). The display electrodes 12 (12X, 12Y) are formed of, for example, a transparent electrode and a bus electrode. On the front glass substrate 11, the display electrode 12 group is covered by a dielectric layer 13. On the dielectric layer 13, a protective layer 14 is further formed. The dielectric layer 13 and the protective layer 14 are formed on an entire surface corresponding to a display area (screen) of the PDP 1.

In the rear plate structure 20, on a rear glass substrate 21, a group of address electrodes 22 is arranged in the y direction crossing the display electrodes 12. The address electrode 22 group is covered by a dielectric layer 23. At in-between positions corresponding to the address electrodes 22 on the dielectric layer 23, barrier ribs 24 are formed in, for example, the y direction. The barrier ribs 24 section a discharge space 26 corresponding to unit emission regions (display cells). In the regions sectioned by the barrier ribs 24 above (z direction) the address electrodes 22, phosphors (phosphor layers) 25 (25r, 25g, 25b) of each color of R (red), G (green), and B (blue) are sequentially formed with color coding per regions (columns).

In internal regions formed by attaching the front plate structure 10 and the rear plate structure 20, a discharge gas (for example, gas of Ne to which about several % of Xe is mixed) is sealed, so that airtight discharge spaces 26 are formed. A peripheral portion of the PDP 1 is attached by a sealing material. The display cell is formed corresponding to an intersecting portion of the sustain electrode 12X, the scan electrode 12Y, and the address electrode 22.

In the drive (sub-field method or address-, display-period separation method) of the PDP 1, discharge (address discharge) is generated by a voltage application across the address electrode 22 and the scan electrode 12Y in the display cell selected (address operation period). Also, to the selected display cell, discharge (sustain discharge (display discharge) etc.) is generated by a voltage application across the pair of the display electrodes 12 (12X, 12Y). Through these steps, emission (turn on) at desired display cells in subfields is performed. Also, by selecting subfields to be turned on in a field, luminance of pixels (display cells) is expressed.

<PDP (Detailed Structure)>

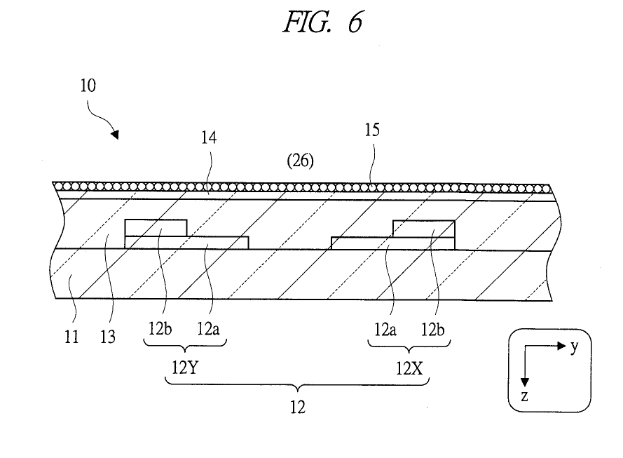

FIG. 6 is a diagram illustrating an example of a cross-sectional configuration of the front plate structure 10 including the priming particle emitting layer. The front plate structure 10 of the PDP 1 includes the priming particle emitting layer 15 formed to be exposed to the discharge space 26 on the protective layer 14. The priming particle emitting layer 15 is a magnesium oxide crystal layer containing magnesium oxide (MgO) crystal powder. Alternatively, the priming particle emitting layer 15 contains magnesium oxide crystal powder to which halogen of fluoride (F) or the like is added. Note that, in the priming particle emitting layer 15, magnesium oxide crystal powder is distributed densely or sparsely to a subject surface (protective layer 14) (note that it is called “layer (film)” even when the magnesium oxide crystal powder is sparsely distributed).

For the front plate glass substrate 11, a transparent material such as glass can be used. The display electrodes 12 can be formed of a transparent electrode 12a of ITO (indium tin oxide) or the like having a large width and forming a discharge gap, and a bus electrode 12b of a metal such as Cu, Cr, or the like having a small width and lowering an electrode resistance. While shapes of the electrodes are not particularly limited, for example, the transparent electrode 12a is in a plate-like shape or a T-like shape per display cells, and the bus electrode 12b is in a linear-line shape.

The display electrodes 12 form a display line by a pair of the adjacent sustain electrode 12X and scan electrode 12Y. As an electrode array configuration, a normal configuration for providing a pair of the display electrodes 12 to be a non-discharge region (reverse slit) or a so-called ALIS (Alternate Lighting of Surfaces Method) configuration alternately arraying the display electrodes 12 (12X, 12Y) at even interval and forming display lines by all pairs of the display electrodes 12 is possible.

The dielectric layer 13 is formed by, for example, applying a low-melting-point glass paste onto the front glass substrate 11 by screen printing or the like and baking the same. The protective layer 14 has functions of protecting the dielectric layer 13, emitting secondary electrons, etc. The protective layer 14 is formed of a metal oxide such as magnesium oxide, calcium oxide, strontium oxide, barium oxide, or the like, and preferably formed of a magnesium oxide layer having a high secondary electron emission coefficient. The protective layer is formed by, for example, electron beam evaporation deposition (or sputtering, application method, etc.).

The rear plate structure 20 can be manufactured in, for example, the following way using prior art. Regarding the rear glass substrate 21, address electrode 22, dielectric layer 23, etc., they can be manufactured in the same manner as the front plate structure 10. The barrier rib 23 can be in a stripe shape only in the y direction or a box shape having barrier rib portions in the x direction and y direction, for example. The phosphors 25 are formed by, for example, applying phosphor pastes to regions between the barrier ribs 24 by screen printing, dispenser, or the like per R, G, B and baking the same.

<Priming Particle Emitting Layer (Magnesium Oxide Crystal Layer>

The priming particle emitting layer (magnesium oxide crystal layer) 15 is arranged at any portion exposed to the discharge space 26 in the plate structures forming the PDP 1. For example, a configuration in which the priming particle emitting layer 15 is directly arranged on the dielectric layer 13 or a configuration in which the priming particle emitting layer 15 is arranged on the protective layer 14 on the dielectric layer 13, etc. can be used. In the present embodiment, as illustrated in FIG. 6, the configuration is such that the priming particle emitting layer 15 is arranged on the protective layer 14 in the front plate structure 10. By using the configuration in which the priming particle emitting layer 15 is arranged to be exposed to the discharge space 26, the priming particle emitting layer 15 can give a function of emitting priming particles to the discharge space 26 and an effect of improving discharge delay in the PDP 1.

The priming particle emitting layer 15 includes a priming particle emitting powder material. The priming particle emitting powder material includes magnesium oxide crystal powder (powder) or magnesium oxide crystal powder to which halogen is added.

Types of the halogen to be added are one or two or more from fluoride (F), chlorine, bromine, iodine, etc. It has been confirmed that the improvement effect of discharge delay lasts long when using fluoride. An amount of the halogen to be added is, for example, 1 to 10000 ppm. As substances containing halogen, there are magnesium fluoride (MgF₂) which is a halide of magnesium, and halides of Al, Li, Mn, Zn, Ca, and Ce.

Baking of the substance containing magnesium oxide crystal powder is performed within a range of, for example, 1000 to 1700° C. A particle diameter of the magnesium oxide crystal powder or magnesium oxide crystal powder to which halogen is added after a thermal treatment is preferable to be within a predetermined range (50 nm to 20 μm). When the particle diameter is too small, the improvement effect of discharge delay by the priming particle emitting layer 15 is small. Also, on the contrary, when the particle diameter is too large, it is difficult to uniformly form the priming particle emitting layer 15.

A basic method of forming the priming particle emitting layer 15 is as follows, for example. A material (material containing priming particle emitting powder) in a state of paste or slurry made by mixing magnesium oxide crystal powder in a solvent (flux) is prepared. This material is deposited to a subject surface by spraying (dispersing) or application. For example, a slurry spraying or a paste dispersing such as a printing method can be used. Solvent components etc. are removed by drying or baking the deposited material to fixedly attach the powder components to the subject surface, thereby finishing it as the priming particle emitting layer 15. The priming particle emitting layer 15 is, for example, formed to an entire surface of the subject surface (surface of the protective layer 14) having a predetermined thickness.

### First Embodiment

Hereinafter, a method of producing/manufacturing the magnesium oxide crystal powder and the PDP 1 including the priming particle emitting layer 15 containing the magnesium oxide crystal powder according to a first embodiment of the present invention will be described. The method of manufacturing the PDP 1 of the present embodiment has a pretreatment process for uniforming shapes and sizes of particle groups to each other before subjecting raw material powder of the magnesium oxide crystal powder to a high-temperature heating treatment.

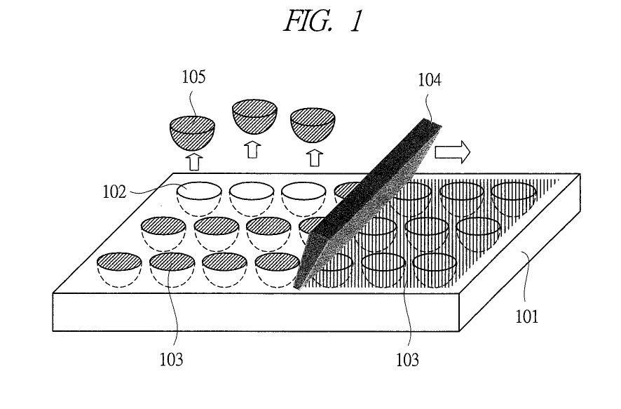

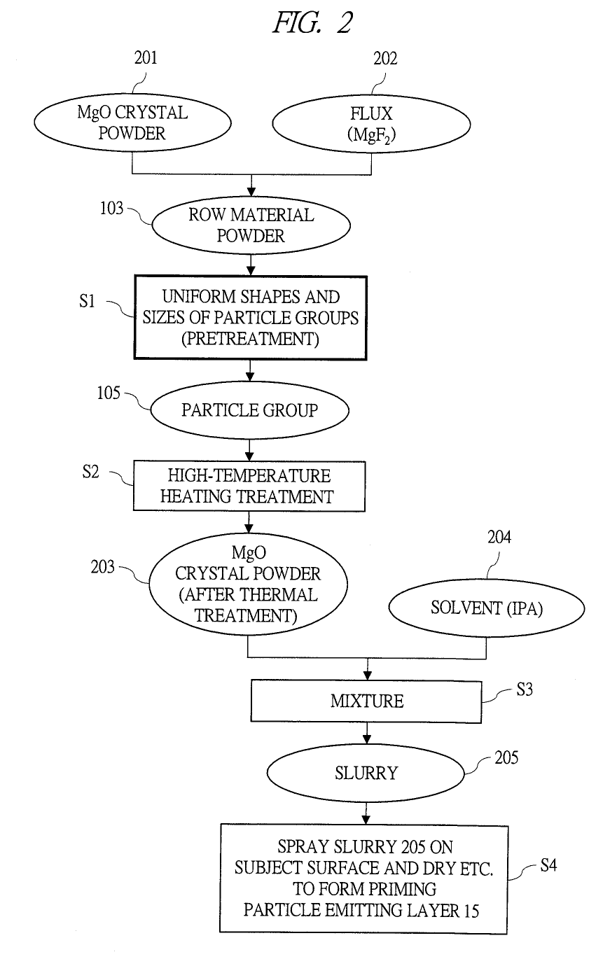

FIG. 1 is a diagram illustrating an outline of an example of a pretreatment process for uniforming shapes and sizes of particle groups according to the present embodiment, FIG. 2 is a diagram illustrating a manufacture flow of magnesium oxide crystal powder and the priming particle emitting layer 15 including the pretreatment process according to the present embodiment.

Regarding FIG. 2, in the present embodiment, as raw material powder 103 before performing a high-temperature heating treatment (step S2), a material made by adding magnesium fluoride (MgF₂) which is a magnesium halide as a flux (substance which works to lower melting point of magnesium oxide (flux)) 202 to magnesium oxide (MgO) crystal powder 201 is used.

Here, product name: (Vapor Phase Method) High Purity & Ultrafine Magnesia Powder (2000A) manufactured by Ube Material Industries, Ltd. is used for the magnesium oxide crystal powder 201, and magnesium fluoride (MgF₂) (purity: 99.99%) manufactured by Furuuchi Chemical Corporation is used for the flux 202, and they are mixed at a ratio of molar ratio MgO:MgF₂=1:0.0001. Note that the state of the raw material powder 101 may be, other than the dry powder state, a slurry state mixed with a volatile solvent or a binder may be mixed.

As to the raw material powder 103, a process as illustrated in FIG. 1 is performed for example as the pretreatment (step S1) for uniforming shapes and sizes of particle groups. In FIG. 1, a substrate 101 having a surface to which a plurality of concave holes 102 are provided is first prepared. A size of the concave hole 102 (width and depth of opening) depends on a grain size distribution of the powder after a heating treatment, design of an allowable upper limit of generation of clusters of magnesium oxide crystal, thermal treatment conditions, a size of display cell, etc., and is preferable to be 1 to 100 μm.

While material of the substrate 101 is not particularly limited, metal glass, resin, etc. can be used. In the present embodiment, the concave holes 102 of openings having a width of 50 μm and depth of 25 μm are formed to a surface of the substrate 101 of a flat plate using glass by sandblasting. Note that the substrate 101 may be, for example, a roll shape other than the front plate shape. Also, while the shape of the concave hole 102 is illustrated as a hemisphere shape, it is not particularly limited to this.

The raw material powder 103 is filled in the concave holes 102 on the substrate 101 by levelling using a squeegee 104 or the like. Thereafter, by applying vibration etc. after turning over the substrate 101, particle groups 105 formed of the raw material powder 103 uniformly casted in the shape and size of the concave hole 102 are obtained.

Next, the obtained particle groups 105 are collected to a tray for a high-temperature heating and a high-temperature heating treatment (step S2) is performed. When a slurry and/or binder is mixed in the raw material powder 103, a drying treatment is performed before the collecting. To suppress contacts between the particle groups 105 to minimum, from the collecting to the high-temperature heating treatment, take care not to apply vibration, pressure, etc. to the obtained particle groups 105. In the present embodiment, the obtained particle group 105 are subjected to a thermal treatment in an oxidizing atmosphere of nitride (N): oxygen (O)=4:1 at 1450° C. for 4 hours.

The magnesium oxide crystal powder 203 after the thermal treatment is mixed at a rate of 2 g in 1 L (2 g/l L) of IPA (isopropyl alcohol) which is a solvent 204 to obtain a slurry 205.

The slurry 205 is sprayed (dispersed) or applied using a spray gun for paint to a surface (subject surface) of the protective layer 14 of the front plate structure 10 to which the protective layer 14 (magnesium oxide layer) has been already formed by evaporation in FIG. 6, thereby forming the layer (film). And, by drying (removing solvent components etc.) the layer (slurry 205) by warming, it is finished as the priming particle emitting layer 15 (step S4). Note that an amount of forming (applying) the slurry 205 is set to 2 g/m².

By using the front plate structure 10 to which the priming particle emitting layer 15 is formed in the process described above, the PDP 1 having the configuration illustrated in FIG. 5 is manufactured.

As described above, in the process of manufacturing the priming particle emitting layer 15, as the pretreatment process (step S1) is included, shapes and sizes of the particle groups 105 formed of the magnesium oxide crystal powder 201 can be uniform, and, by reducing contacts of the particle groups 105 to each other during the high-temperature heating treatment (step S2), the magnesium oxide crystal powder 203 having suppressed generation of clusters of magnesium oxide crystal can be obtained without losing a discharge delay improving effect. By arranging the priming particle emitting layer 15 containing the magnesium oxide crystal powder 203, the PDP 1 achieving both an improvement in discharge delay and a suppression of display failure and display unevenness can be achieved.

### Second Embodiment

A method of producing/manufacturing magnesium oxide crystal powder and the PDP 1 having the priming particle emitting layer 15 containing the magnesium oxide crystal powder according to a second embodiment uses another means in the pretreatment step (step S1) for uniforming shapes and sizes of the raw material powder 103 in the manufacture flow of the magnesium oxide crystal powder 203 and the priming particle emitting layer 15 illustrated in FIG. 2 of the first embodiment. Contents of process of the other steps are the same as the first embodiment.

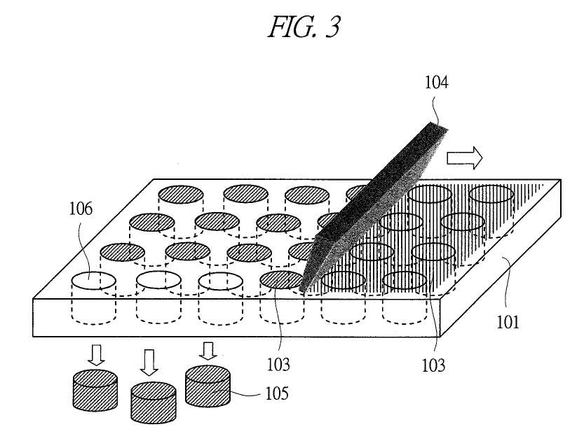

FIG. 3 is a diagram illustrating an outline about an example of the pretreatment process (step S1) for uniforming shapes and sizes of particle groups according to the present embodiment. First, a substrate 101 having a surface to which a plurality of through-holes 106 are provided is prepared. A size of the through-hole 106 (width of opening and thickness of substrate) depends on a grain size distribution design of an allowable upper limit of generation of clusters of magnesium oxide crystal, thermal treatment conditions, a size of the display cell, etc., and it is preferable to be 1 μm to 100 μm.

While material of the substrate 101 is not particularly limited, a metal, glass, resin, or the line may be used. And, the substrate 101 may be in a plate shape, and it may be a shape interweaved with wires etc. In the present embodiment, the substrate 101 is formed by interweaving SUS wires to have openings having a width of 50 μm. Note that, while a shape of the through-hole 106 is illustrated in FIG. 3 as a pillar shape, it is not particularly limited to this.

To the through-holes 106 of the substrate 101, the raw material powder 103 is pushed at a constant pressure using a squeegee 104 or the like to pass through the through-holes 106. In this manner, shapes and sizes of the particle groups 105 formed of the raw material powder 103 passed through the through-holes 106 are uniformed. Note that the raw material powder 103 used here is the same as that of the first embodiment. Also, in the same manner as the first embodiment, the state of the raw material powder 103 may be, other than the dry powder state, a slurry state mixed with a volatile solvent or a material mixed with a binder.

As described above, in the same manner as the first embodiment, in the process of manufacturing the priming particle emitting layer 15, as the pretreatment process (step S1) is included, shapes and sizes of the particle groups 105 formed of the magnesium oxide crystal powder 201 can be uniform, and, by reducing contacts of the particle groups 105 to each other during the high-temperature heating treatment (step S2), the magnesium oxide crystal powder 203 having suppressed generation of clusters of magnesium oxide crystal can be obtained without losing a discharge delay improving effect. By arranging the priming particle emitting layer 15 containing the magnesium oxide crystal powder 203, the PDP 1 achieving both an improvement in discharge delay and a suppression of display failure and display unevenness can be achieved.

While the invention made by the inventors of the present invention has been concretely described based on the embodiments in the foregoing, it is needless to say that the present invention is not limited to the foregoing embodiments and various modifications and alterations can be made within the scope of the present invention.

### INDUSTRIAL APPLICABILITY

The present invention can be used for a PDP and a method of manufacturing the same.

1. A method of manufacturing a plasma display panel in which a priming particle emitting layer which contains magnesium oxide crystal powder subjected to a high-temperature treatment is arranged to be exposed to a discharge space between two plate structures arranged to face each other, the method comprising
a step of pretreatment for uniforming sizes and shapes of particle groups formed of a plurality of particles of the magnesium oxide crystal powder before performing the high-temperature heating treatment to the magnesium oxide crystal powder.

2. The method of manufacturing the plasma display panel according to claim 1, wherein,
in the pretreatment step, the magnesium oxide crystal powder is filled and casted in concave holes provided on a substrate, thereby uniforming shapes and sizes of the particle groups formed of the plurality of particles of the magnesium oxide crystal powder.

3. The method of manufacturing the plasma display panel according to claim 2, wherein
a size of the concave hole is 1 to 100 μm.

4. The method of manufacturing the plasma display panel according to claim 1, wherein,
in the pretreatment step, the magnesium oxide crystal powder is pushed into and passed through through-holes provided on a substrate, thereby shapes and sizes of the particle groups formed of the plurality of particles of the magnesium oxide crystal powder.

5. The method of producing the magnesium oxide crystal powder according to claim 4, wherein,
a size of the through-hole is 1 to 100 μm.

6. A method of manufacturing a plasma display panel in which a priming particle emitting layer which contains magnesium oxide crystal powder subjected to a high-temperature treatment is arranged to be exposed to a discharge space between two plate structures arranged to face each other, wherein,
when performing the high-temperature heating treatment to the magnesium oxide crystal powder, particles or particle groups formed of a plurality of particles of the magnesium oxide crystal powder having uniform shapes and sizes are used.

7. A method of producing magnesium oxide crystal powder subjected to a high-temperature heating treatment, the magnesium oxide crystal powder being contained in a priming particle emitting layer arranged to be exposed to a discharge space between two plate structures arranged to face each other, the method comprising
a step of pretreatment for uniforming sizes and shapes of particle groups formed of a plurality of particles of the magnesium oxide crystal powder before performing the high-temperature heating treatment to the magnesium oxide crystal powder.

8. The method of producing the magnesium oxide crystal powder according to claim 7, wherein,
in the pretreatment step, the magnesium oxide crystal powder is filled and casted in concave holes provided on a substrate, thereby uniforming shapes and sizes of the particle groups formed of the plurality of particles of the magnesium oxide crystal powder.

9. The method of producing the magnesium oxide crystal powder according to claim 8, wherein,
a size of the concave hole is 1 to 100 μm.

10. The method of producing the magnesium oxide crystal powder according to claim 7, wherein,
in the pretreatment step, the magnesium oxide crystal powder is pushed into and passed through through-holes provided on a substrate, thereby shapes and sizes of the particle groups formed of the plurality of particles of the magnesium oxide crystal powder.

11. The method of producing the magnesium oxide crystal powder according to claim 10, wherein,
a size of the through-hole is 1 to 100 μm.
